(19) United States
(12) Patent Application Publication
(10) Pub. No.: US 2026/0116660 A1
(43) Pub. Date: Apr. 30, 2026

(54) TRAY, STORAGE SHELF AND METHOD FOR AUTOMATICALLY LOADING AND REMOVING STORAGE GOODS

(71) Applicant: Rainer Vogt, Neuenstadt (DE)

(72) Inventor: Rainer Vogt, Neuenstadt (DE)

(21) Appl. No.: 19/116,804

(22) PCT Filed: Sep. 27, 2023
(86) PCT No.: PCT/EP2023/076805

§ 371 Date: Mar. 28, 2025

(30) Foreign Application Priority Data
Sep. 29, 2022 (DE) 10 2022 125 195.0

(51) Int. Cl. B65G 1/04; B25J 5/02; B25J 19/00

(52) U.S. Cl. CPC B65G 1/04; B25J 5/02; B25J 19/0045; B65G 2201/0258

(57) ABSTRACT

The invention relates to a tray (10) for a storage rack (100), wherein the storage rack (10) has an automatic transport device (110), an operating opening (120) and a plurality of beam supports (130) arranged one above the other for supporting the tray (10), which form storage locations (103), wherein the tray (10) can be conveyed from and to the operating opening (120) by means of the automatic transport device (110), and wherein the tray (10) can be picked up in the storage locations (103). The tray (10) is characterized by a robot (20) arranged on the tray (10) for handling stored goods (50).

The invention relates to a tray for a storage rack for the automatic loading and removing of stored goods, a storage rack with such a tray and a method for such a storage rack.

In automated storage racks, trays for accommodation of the stored item are stored and retrieved via an operating opening by means of an automatic transport device and stored in or retrieved from the storage locations provided in the storage rack. Such trays are also known as containers or stored goods carriers. The transport device is usually arranged between the spaced-apart storage towers of the storage rack and has an extractor for feeding and removal of the stored goods carriers. An operator can retrieve goods stored on the tray or place them on the tray via the operating opening. Such an automatic storage rack is known, for example, from EP 1 934 120 A1.

The supportive use of robots for handling stored goods during storage and retrieval is well known. See, for example, DE 10 2015 220 091 A1 or EP 3 263 491 A1. The robots are stationarily connected to a vehicle or the storage rack, which provides electricity for operating the robot and offers secure fastening.

It is also known from EP 3 564 165 A1 that a robot can be positioned on an automatic transport device to support loading and removing. The robot is supplied with electricity for the operation of the robot via the transport device.

It is known from EP 3 957 580 A1 to provide a robot in a transport shaft, whereby the robot is arranged on a ceiling of the storage rack above a transport device.

The object of the invention is to carry out the storage and retrieval of stored goods from the storage rack, in particular from the transport device, more efficiently.

This object is solved by a tray with the features of claim 1, a storage rack for automatic loading and removing of stored goods according to claim 12 and a method according to claim 13.

Advantageous embodiments are the subject of the dependent claims.

The tray for a storage rack according to the invention has a robot arranged on the tray for handling stored goods.

The tray according to the invention has the advantage that storage and retrieval processes, picking stored goods and/or assembly of separate parts can be supported and even fully automated by the robot. For example, the storage and retrieval process can even be carried out or at least prepared by the robot at night while no warehouse staff are working. It is also conceivable that the robot could also take over the assembly of individual parts during handling. Handling therefore means not only picking up and placing stored goods, but also the assembly or picking of stored goods. When assembling stored goods, for example, a stored item is brought together with another stored item by the robot.

The arrangement of the robot on the tray means that support can be provided for loading and removing as required. If this support is not required, the tray with the robot can be stored in the storage locations provided in the storage rack. Furthermore, it is particularly advantageous that the tray with the robot can be positioned in the operating opening. The work processes can be carried out more efficiently with the help of the robot, thereby speeding them up.

This has a particularly advantageous effect when processing a collective order that includes a plurality of different stored goods to be retrieved, which are stored on several trays in particular. This is because in such a case, for example, the tray according to the invention can be positioned in the operating opening and another tray in front of the operating opening on a stem.

The stored goods to be retrieved are then simply moved on the respective tray by the automatic transport device behind the operating opening and adjacent to the tray with the robot in the operating opening. The robot in the operating opening can then pick up the stored goods to be retrieved directly from the tray on the transport device and place or mount them on the tray temporarily stored on the stem in front of the operating opening. From there, this tray can be put back into storage with the picked stored goods of the collective order on a tray or transported further by an operator or an autonomous industrial truck. This process for picking and preparing for retrieval can be carried out at night.

Storage can be carried out in the reverse order to retrieval. Here, the robot removes a stored item from the tray stored in front of the operating opening and places it on the tray located in the transport shaft on the automatic transport device.

The side walls of the operating opening provide additional protection from the robot.

A storage rack is to be understood in particular as a storage lift with a closed housing and an automatic transport device with an extractor.

A robot is to be understood in particular as a robot that is configured to handle stored goods on an adjacent tray. The robot can have a handling device for handling. This handling device protrudes at least beyond the tray with the robot.

In an advantageous embodiment, the robot is configured as a collaborative robot. In this case, it is possible for the robot to load and remove while an operator also stores or retrieves stored goods in parallel.

A collaborative robot, also known as a cobot, is an industrial robot that can work together with humans and is not separated from humans, such as operators, by protective devices. The robot can be configured in such a way that it has sensors that control the robot in such a way that humans are not injured by the operation of the robot.

Advantageously, the robot has at least a first member, a second member and a handling device. Joints are preferably arranged between the members and the handling device.

For example, the robot can use the at least two joints and the handling device to pick up stored goods from the adjacent tray in the transport shaft and place them on the other adjacent tray in front of the operating opening

Advantageously, the tray has a base and an edge area surrounding the base, which protrudes from the base. The edge area protruding from the base gives the tray a high level of stability. In addition, the edge area prevents collisions between the stored goods and the supports of the storage tray.

The robot is advantageously positioned in the center of the tray. The centered position gives the robot additional stability as the tray acts as an extended foot and thus increases the protection against tipping. As a result, heavier or more distant stored goods can be lifted or deposited. The radius of the working area is increased.

In a further advantageous embodiment, the tray has at least one counterweight, which is arranged on a base of the tray, preferably in an edge area of the tray. This also increases the tip stability.

Furthermore, the tray can be fixed in place by the storage rack. For this purpose, the tray has a tip protection element in the edge area adjacent to the side wall of the operating opening, which can be brought into engagement with a corresponding tip protection device in the side wall of the operating opening. The tip protection element can, for example, only be an area of the tray or a protruding pin or driver. The tip protection device of the operating opening can be an undercut or a recess or an area in the operating opening that protrudes over the tray in some areas, whereby the tray is fixed in the vertical direction in such a way that the tray cannot tip.

In a further advantageous embodiment, the tray can also have such a tip protection element on one end face, which can be brought into engagement with a projecting tip protection device arranged at the front of the operating opening.

It is also conceivable that the extractor of the transport device can serve as a tip protection device. The extractor usually has at least one telescopically extendable arm, which is used to push the tray into or pull it out of the operating opening or into a storage location by means of a driver chain. To prevent tipping, the extractor can be brought into engagement with the tray in the operating opening during handling by means of the driver chain and thus also limit the tray with the robot in the vertical direction.

Advantageously, the tray has a power supply device for the robot, which comprises a contact unit that can be connected to a mating contact unit arranged in the operating opening for the transmission of electricity to a power supply system. This allows the robot to be supplied with electricity directly. Accordingly, the tray only needs to have a smaller power storage unit or even no power storage unit at all and is correspondingly lighter. Furthermore, the direct power supply ensures longer operation. As the robot only processes orders in the operating opening, this embodiment ensures safe operation of the robot. Furthermore, the robot can be supplied with a higher voltage so that it can carry higher loads. The power storage unit can be recharged during a phase in which the robot only draws a low voltage.

In an advantageous further development, the power supply device has an induction coil for inductive power supply. Especially in logistics, dust or other environmental influences often occur when handling stored goods. As the induction coil is preferably an integral part of the tray, these environmental influences do not occur during the transmission of electricity. This creates a simpler and more maintenance-free device. It is preferable to integrate the induction coil in a base surface of the tray. However, it is alternatively possible to provide the induction coil in a contact unit arranged on the tray and to provide the mating contact unit on the storage rack.

Advantageously, the tray has a power storage unit, in particular an accumulator. The power storage unit can supply the robot with electricity independently of a power grid. Furthermore, the power storage unit can also act as a counterweight. This makes it possible for the robot to be operated in stand-alone mode for at least a short period of time. For example, the robot can be brought into a position for the storage or retrieval of stored goods shortly before it is connected to the power supply via a power supply device. For example, the robot can be brought from an idle state to a standby state during transport by means of the transport device from a storage location to the operating opening.

It is also conceivable that the robot grips a tray that is already in the operating opening during insertion into the operating opening and pushes it parallel onto the stem in front of the operating opening. This means that there is no need for an additional extractor to move the tray from the operating opening onto the stem. In a further advantageous development, the tray with the robot has a deployable safety device that replaces the safety light curtain in front of the stem. The deployable safety device serves in particular to fulfil the safety requirements for personal protection without the need to permanently install a safety light curtain on the storage rack. The safety device ensures that an operator does not get their fingers trapped between the tray and the storage rack when moving the trays, for example.

Advantageously, the tray comprises an interface for transmitting control commands and/or safety commands for the robot. The interface is connected to the control system of the storage rack and, in particular, to a storage system that coordinates the work processes. In this respect, storage and retrieval can be carried out autonomously.

For each stored item, the area on the tray in which the stored item is located is stored in the control system of the storage rack. The robot moves the handling device in the direction of the area. The stored goods can then be handled precisely using a search unit connected to the robot, such as a camera positioned next to the handling device. Such a device is particularly advantageous for gripping individual parts, such as screws, from a container, as usually only the area of the container is stored in the control system of the storage rack.

The robot can be arranged on the tray so that it can be moved. This makes it easy to adapt to the size of the stored goods. The working area of the robot can also be adjusted.

In an advantageous embodiment of the tray, it has a linear displacement device. The linear displacement device comprises a rail and a carriage that can be moved on the rail and on which the robot is arranged. The rail preferably runs parallel to an end face of the tray. Furthermore, in a further preferred embodiment, the rail and the carriage are configured to transmit electricity for the robot.

Due to the additional linear displacement of the robot's position, the radius of the working area can be increased evenly along the width of the stored goods carrier. The end face of the tray faces the operator in a position located in the operating opening. The rail therefore runs along a horizontal X-direction. In a preferred embodiment of this, the rail is connected adjacent to two opposite sides of the edge area of the tray. The opposite sides of the edge area connected to the rail are arranged running along a Y-direction. In a further preferred embodiment, the rail is arranged in the center along the extension of the tray in the Y direction. The centered arrangement of the rail provides the robot with additional stability, as the tray acts as an extended foot and thus increases the protection against tipping. As a result, heavier or more distant stored goods can be lifted or deposited.

All embodiments of the tray according to the invention are characterized by the fact that the tray with the robot can be stored in the same way as a tray without a robot. The height of the tray with a robot is determined by the height measuring device of the storage rack. The tray can be delivered to or removed from a suitable storage location in the storage rack by means of the transport device. The storage location can also be configured to charge the power storage unit of the tray.

A further aspect of the invention relates to a storage rack characterized by a tray as described above. The storage rack can have trays with robots and trays without robots.

A further aspect of the invention comprises a method for a storage rack as described above. The method comprises the following steps. Step a) conveying a first tray with a robot, as previously described, into the operating opening. Step b) moving a second tray adjacent to the first tray. Step c) handling a stored item by means of the robot on the second tray.

The method enables the automated handling of stored goods by means of the storage rack described above with the tray described above comprising a robot. In an advantageous further development of the method, a third tray is conveyed in front of the operating opening before step a). In this case, no tray set down by an operator needs to be deposited. Consequently, for example, the entire retrieval process can be performed autonomously. Advantageously, the stored goods are picked up or deposited from the third tray by the robot.

The invention is explained in more detail below with reference to various embodiments, which are shown schematically in the figures. They show:

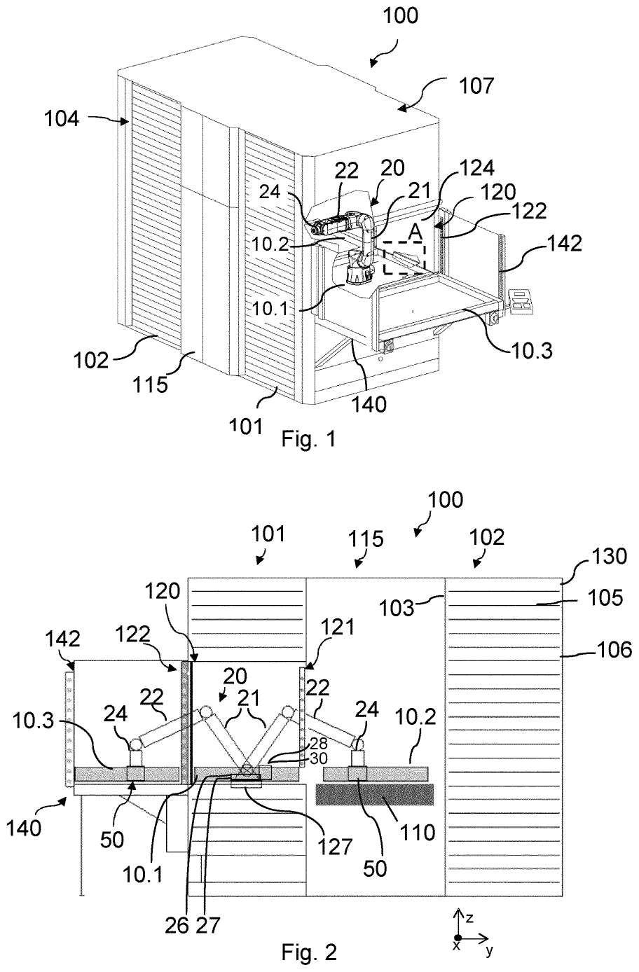

FIG. 1 a perspective view of the tray according to the invention in a storage rack,

FIG. 2 a cross-section of the storage rack as shown in FIG. 1,

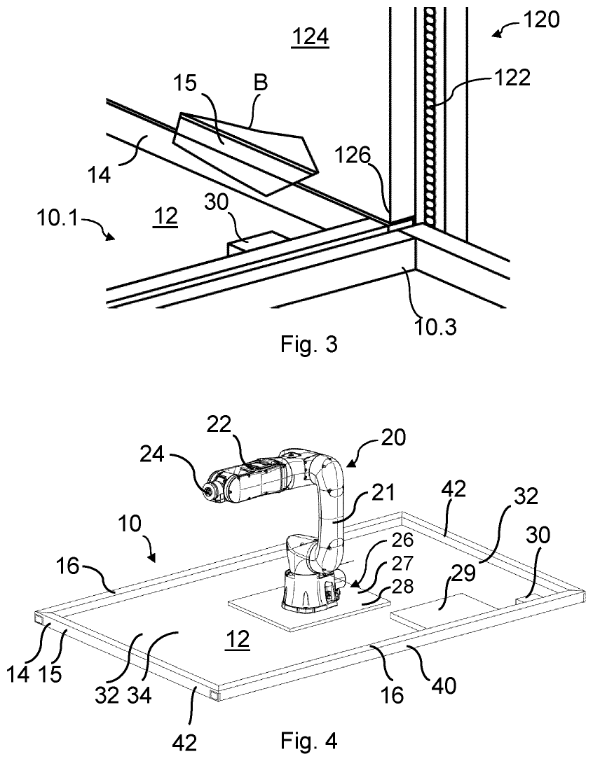

FIG. 3 an enlarged detailed view of area A in FIG. 1,

FIG. 4 the tray according to the invention with a robot,

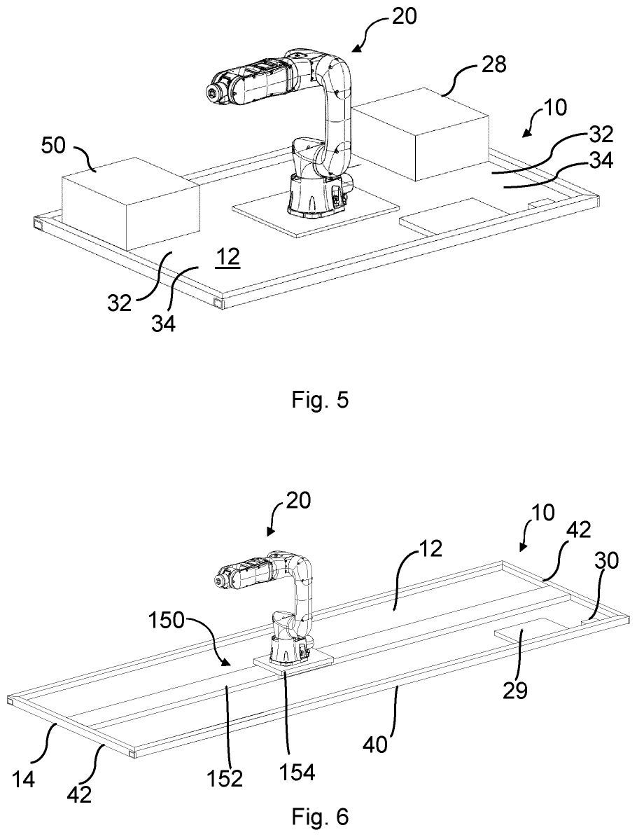

FIG. 5 the tray according to the invention as shown in FIG. 4 with temporarily stored goods and

FIG. 6 an advantageous embodiment of the tray with a displaceable robot.

FIGS. 1 and 2 show the schematic structure of a storage rack 100 with a first rack tower 101, a second rack tower 102 and a transport shaft 115 for an automatic transport device 110 arranged between the two rack towers 101, 102.

In each rack tower 101, 102 there are a plurality of storage locations 103 arranged one above the other to accommodate trays 10. Stored goods 50 can be stored on the trays 10. In order to store the trays 10 in the individual storage locations 103, the rack towers 101, 102 have side walls 104 with opposing support pads 105 in pairs, which form a housing 107 enclosing the storage rack 100. The side walls 104, made of sheet steel, are each welded to uprights 106, preferably using projection welding technology. The support pads 105 are integrated into the respective side wall 104 and pressed into it in a meandering shape. This ensures that the side walls 104 are comparatively rigid.

The storage rack 100 has an operating opening 120, which makes it possible to load the storage rack 100 with trays 10 or to remove the trays 10 from the storage rack 100. Furthermore, the operating opening 120 enables the removal or supply of stored goods 50 from or onto the tray 10. The operating opening 120 is laterally delimited by two spaced-apart side walls 124 of the storage rack 100.

In order to achieve optimum use of the storage space, a height measuring device 121 for measuring the height of the stored goods 50 is provided in the rear area of the operating opening 120. The height measuring device 121 is equipped with a plurality of light barriers, which are apart at a distance corresponding to the distance between the support pads 105 lying one above the other, so that the number of height units required for storing the stored goods 50 can be determined.

A safety light curtain 122 is arranged on a front side of the operating opening 120. The safety light curtain 122 serves to recognize whether an operator is reaching into the operating opening 120. As soon as this is recognized, for example, the transport of the tray 10 from the transport device 110 into the operating opening 120 is stopped so that the operator 120 cannot become trapped.

In front of the operating opening 120 there is a stem 140, which in the illustration shown comprises two spaced-apart rails with rollers. The tray 10 can be pushed onto the rails up to an abutment in front of the operating opening 120 by means of an extractor and temporarily stored there. A further safety light curtain 142 is arranged at the outer end of the stem 140. As soon as a tray 10 is moved onto the stem, the safety light curtain 122 is replaced by the safety light curtain 142.

To feed or remove the tray 10 into or from the operating opening 120 or a storage location 103, the transport device 110 has an extractor. The extractor comprises two telescopically extendable arms, which are provided with a driver chain. The extractor can be brought into engagement with the tray 10. This allows the extractor to feed the tray 10 into or remove it from the storage locations 103.

To retrieve a tray 10 stored in a storage location 103, the transport device 110 grips the tray 10 by means of the extractor and pulls it onto the transport device 110. The transport device 110 then moves along the vertical and longitudinal directions to the operating opening 120, into which the transport device 110 feeds the tray 10.

The controllable transport device 110 is set up in such a way that the tray 10 can be moved vertically in a first spatial direction Z and horizontally by means of the extractor in a second spatial direction Y. In a further possible embodiment of the storage rack 100 with several rack towers 101, 102 arranged next to each other, the transport device 110 is configured in such a way that it can also move the tray 10 in a further horizontal spatial direction X. The three spatial directions X, Y, Z are at right angles to each other in the present embodiment example.

The tray 10 has a robot 20, which is configured as a collaborative robot (cobot).

The tray 10 has a base 12 and an edge area 14 surrounding the base 12, which projects from the base 12. The edge area 14 comprises a tip protection element 15 in a side 42 facing the side wall 124 of the operating opening 120. As shown in FIG. 4, the tip protection element 15 is an integral part of the edge area 14. This can also be arranged on an end face 40 of the tray 20. Furthermore, the interaction of the tip protection element 15 with the tip protection device 126 of the side wall 124 is shown in FIG. 3. For this purpose, the area B of the side wall 124 is shown cut out in FIG. 3.

To further increase the stability of the tray 10, the edge area 14 has a counterweight 16 on the end face 40 of the tray 12 and on the side opposite the end face 40, also in the edge area 14.

The base 12 can also have a reinforcing plate. The reinforcing plate is an additional metal plate that is connected to the base 12 and reinforces it.

As shown in FIG. 2 and FIG. 4, a power supply device 26 for the robot 20 is provided on the tray 10. The power supply device 26 has a contact unit 27, which can be connected to a corresponding mating contact unit 127 arranged in the operating opening 120 for transmitting electricity from a power supply system. The power connection can be configured to be conductive by means of contacts or inductive by means of an induction coil.

The power supply device 26 for the robot 20 can also have a power storage unit 28, in particular an accumulator.

The tray 10 also has an interface 30 for transmitting control commands for the robot 20. The interface 30 for transmitting control commands to the robot 20 is configured to communicate, for example via radio, with the control system of the storage rack 100 for transmitting control commands and/or safety commands. The interface 30 is assigned a control unit 29 for controlling the robot 20, which is attached to the base 12 of the tray 10.

Furthermore, the tray 10 with the robot 20 has an intermediate buffer surface 34. The intermediate buffer surface 34 can also serve as a mounting plate. As shown in FIG. 5, stored goods 50 can be deposited on the intermediate buffer surface 34. The power storage unit 28 can also be arranged in the same area of the intermediate buffer surface 34.

The robot 20 comprises a first member 21, a second member 22 and a handling device 24. The members 21, 22 and the handling device 24 are each connected to each other via joints, whereby the robot 20 can be moved in a plurality of degrees of freedom.

The handling device 24 is configured to handle various stored goods 50. Depending on the stored goods 50 to be picked up, the handling device 24 can have different embodiments. One possible embodiment is, for example, a gripping device. In a preferred embodiment, the robot 20 can be configured in such a way that it can change the handling device 24. Furthermore, a camera is arranged in the area of the handling device 24.

As shown in FIG. 3, the side wall 124 of the operating opening 120 has a tip protection device 126. The tip protection device 126 comprises a projecting area of the side wall 124 and a recess. The upper side of the recess projects beyond the edge area 14 of the tray 10. The tip protection device 126 serves to limit movement of the tray 10 in the vertical direction.

FIG. 6 shows a further advantageous embodiment of the tray 10. The advantageous embodiment of the tray 10 is characterized by a linear displacement device 150 for the robot 20. The linear displacement device 150 comprises a rail 152 and a carriage 154, which can be moved on the rail 152 and on which the robot 20 is arranged. The displaceable arrangement of the robot 20 on the tray 10 enables easy adaptation to the size of the stored goods. The working area can also be adjusted.

The rail 152 runs parallel to an end face 40 of the tray 10. The end face 40 of the tray 10 faces an operator in a position arranged in the operating opening 120. Accordingly, the rail 152 extends along a horizontal X-direction, which is parallel to the side of the storage tray 100 with the operating opening 120.

The rail 152 is connected to the two opposite sides 42 of the edge area 14 of the tray 10. The opposite sides 42 of the edge area 40 connected to the rail 152 are arranged running along a Y-direction.

Furthermore, the rail 152 is arranged centrally along the extension of the tray 10 in the Y-direction and is thereby connected to a central area of the opposite sides 42 of the edge area 14 extending along the Y-direction.

The robot 20 is fixed on the carriage 154 and can be moved in the X direction. The carriage 154 can be driven by an electric motor that is controlled by a control device.

With reference to FIG. 2, the method according to the invention is described below by way of example using a possible removal process of a stored item 50. However, a combination of the individual steps or a corresponding method for storing stored goods 50 is also included. In FIG. 2, the robot 20 is shown in two possible positions.

In a first step of the method, a third tray 10.3 without stored goods 50 can be conveyed onto the stem 140 of the storage rack 100 to remove stored goods 50. The tray is then positioned with the robot 20 on a first tray 10.1 in the operating opening 120. The first tray 10.1 is pushed into the operating opening 120. The tip protection element 15 of the tray is pushed into the tip protection device 126. In the operating opening 120, the contact unit 27 is connected to the mating contact unit 127 for transmitting electricity to the robot 20. Subsequently, a second tray 10.2 with the stored goods 50 to be retrieved is brought adjacent to the first tray 10.1 in the operating opening 120 via the transport device 110. For this purpose, the transport device 110 moves to the height of the operating opening 120.

The robot 20 then grips the stored item 50 to be retrieved from the second tray 10.2 and lifts it onto the third tray 10.3, which is positioned on the stem 140 in front of the operating opening 120. Due to the tip protection element 25 and the corresponding tip protection device 126, the tray 10.1 with the robot 20 cannot tip over when handling stored goods 50 on an adjacent tray 10.2, 10.3. The transport device 110 then moves the second tray 10.2 back to the storage position 103 and repeats this step with a further second tray 10.2 with a further stored item 50 to be retrieved. This can be repeated as often as required until, for example, a collective order has been processed. Once the collective order has been processed, the first tray 10.1 is transported back to the designated storage location 103 by the robot 20 and stored.

An operator can then pick up the third tray 10.3 and transport the stored goods 50 further. Alternatively, the third tray 10.3 can be stored again and retrieved when required. This is particularly suitable for processing a collective order during the night and not retrieving it until the next working day.

In a further embodiment, the robot 20 can also perform assembly steps. One example of a possible assembly step is mounting electrical components on a top-hat rail. Another example is the mounting and wiring of electrical components, preferably on a top-hat rail with snap-in terminals. This can be done on the third tray 10.3 or on the mounting area 32.

If the tray 10 with the robot 20 has a power storage unit 28, steps can already be carried out with the robot 20 before it has been connected to the mating contact unit 127. For example, the robot 20 can grip the third tray 10.3 during insertion into the operating opening 120 and push it in parallel onto the stem 140. For this purpose, the first tray 10.1 with the robot 20 could additionally have a fold-out safety device, which the robot 20 also extends and thereby also replaces the safety light curtain 142.

The storage rack 100 with the tray 10 according to the invention, which has a robot 20, can in particular fulfil collective orders autonomously and quickly. The storage and retrieval of stored goods 50 is significantly increased with the aid of the robot 20. Since the robot 20 is not stationary but mobile on the tray 10, it can be used as required.

If the tray 10 with the robot 20 is not required, the tray 10 can be stored in a storage location 103 of the storage rack 100 in the same way as a tray 10 without robot 20. The height measuring device 121 measures the height of the tray 10 with a robot 120. The transport device guides the tray 10 with a robot 20 to a suitable storage location 103. The spaced support pads 105 support the tray 10 with the robot 20.

### LIST OF REFERENCE SYMBOLS

10 tray
12 base
14 edge area
15 tip protection element
16 counterweight
20 robot
21 first member
22 second member
24 handling device
26 electric power supply device
27 contact unit
28 power storage unit
29 control unit
30 interface
32 assembly area
34 intermediate buffer surface
40 end face
42 sides
50 stored goods
100 storage rack
101 first rack tower
102 second rack tower
103 storage locations
104 side walls
105 support pads
106 upright
107 housing
110 transport device
115 transport shaft
120 operating opening
121 height measuring device
122 safety light curtain
124 side wall
126 tip protection device
127 mating contact unit
130 beam supports
140 stem
142 safety light curtain
150 linear displacement device
152 rail
154 carriage

1. A tray for a storage rack, the storage rack having an automatic transport device, an operating opening and a plurality of beam supports arranged one above the other for supporting the tray, which form storage locations, wherein the tray can be conveyed from and to the operating opening and the storage locations by means of the automatic transport device, and wherein the tray can be picked up in the storage locations, characterized in that a robot for handling stored goods is arranged on the tray.

2. The tray according to claim 1, characterized in that the robot is a collaborative robot.

3. The tray according to claim 1, characterized in that the robot comprises at least a first member, a second member and a handling device.

4. The tray according to claim 1, characterized in that the robot is arranged, in particular connected, centrally on the tray.

5. The tray according to claim 1, characterized in that the tray has at least one counterweight which is arranged on a base of the tray, preferably in an edge area of the tray.

6. The tray according to claim 1, characterized by an electric power supply device for the robot,
wherein preferably the electric power supply device has a contact unit which can be connected to a mating contact unit arranged in the operating opening for the transmission of electricity.

7. The tray according to claim 6, characterized in that the electric power supply device has an induction coil.

8. The tray according to claim 1, characterized by a power storage unit, in particular an accumulator, which is suitable for providing electricity to the robot.

9. The tray according to claim 1, characterized by an interface for transmitting control commands for the robot.

10. The tray according to claim 1, characterized in that the robot is arranged on the tray in a displaceable manner.

11. The tray according to claim 1, characterized by a linear displacement device comprising a rail and a carriage that can be moved on the rail, wherein the robot is arranged on the carriage.

12. A storage rack having an automatic transport device, an operating opening and a plurality of beam supports arranged one above the other for supporting trays, which can be conveyed from and to the operating opening by means of the automatic transport device, characterized in that the tray has the features according to claim 1.

13. A method for a storage rack according to claim 12 for automatically handling stored goods, the method comprising the following steps:
a) conveying a first tray with a robot according to claim 1 into the operating opening,
b) moving a second tray adjacent to the first tray, and
c) handling a stored item by means of the robot on the second tray.

14. The method according to claim 13, characterized by conveying a third tray before step a) in front of the operating opening.

15. The method according to claim 14, characterized by handling the stored goods by means of the robot on the third tray.
